(19) United States
(12) Patent Application Publication
(10) Pub. No.: US 2011/0017385 A1
(43) Pub. Date: Jan. 27, 2011

(54) Method of producing a composite article

(75) Inventors: Chih-Lung Liu, Kaohsiung City (TW); Yu-Lung Chen, Kaohsiung City (TW)

Correspondence Address: Paul D. Greeley;Ohlandt, Greeley, Ruggiero & Perle, L.L.P., 10 Floor, One Landmark Square, Stamford, CT, 06901-2682, US

(73) Assignee: ADVANCED INTERNATIONAL MULTITECH CO., LTD.

(21) Appl. No.: 12/653,060

(22) Filed: Dec. 8, 2009

(30) Foreign Application Priority Data
Jul. 27, 2009 (TW) 098125209

(51) Int. Cl. B29C 70/34

(52) U.S. Cl. 156/196

(57) ABSTRACT

A method of producing a composite article includes: hot pressing a stack of prepreg sheets in a mold to form the composite article, the mold having a mold cavity; producing a fine ridge pattern on a surface of the stack of the prepreg sheets during the hot pressing of the prepreg sheets in the mold cavity, the fine ridge pattern having a plurality of ridges which are substantially as fine as those of a fingerprint; and removing the composite article from the mold cavity.

### CROSS-REFERENCE TO RELATED APPLICATION

This application claims priority of Taiwanese application no. 098125209, filed on Jul. 27, 2009.

### BACKGROUND OF THE INVENTION

1. Field of the Invention

This invention relates to a method of producing a composite article, more particularly to a method of producing a composite article with a fine ridge pattern.

2. Description of the Related Art

Composite materials, especially, prepreg sheets (resin-impregnated fabric sheets) are commonly used in making housings of notebook computers, bicycle frames, golf club heads, etc.

FIGS. 1 and 2 show a conventional method of producing a composite article. The method includes: step 101 of providing a mold 12 having two mold halves; step 102 of hot pressing a stack of prepreg sheets 11 in the mold 12 to form the composite article; and step 103 of removing the composite article from the mold 12.

However, when the prepreg sheets 11 are formed within the mold 12, defects, such as pin holes or bubbles are likely to be formed in the composite article, and must be patched or repaired by polishing or grinding.

On the other hand, prepreg sheets are typically formed into a product within a mold cavity. In order to decorate the product with a pattern or colors, the surface of the product is usually coated with a coating material which can pollute the environment.

Therefore, there is a need to provide improvements which can decorate the products made from prepreg sheets without using a coating material and which can also address the problem of pinholes and bubbles.

### SUMMARY OF THE INVENTION

Therefore, an object of the present invention is to provide a method of producing a composite article that can overcome the aforesaid drawbacks associated with the prior art.

According to this invention, a method of producing a composite article comprises:

hot pressing a stack of prepreg sheets in a mold to form the composite article, the mold having a mold cavity;

producing a fine ridge pattern on a surface of the stack of the prepreg sheets during the hot pressing of the prepreg sheets in the mold cavity, the fine ridge pattern having a plurality of ridges which are substantially as fine as those of a fingerprint; and

removing the composite article from the mold cavity.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flowchart showing a conventional method of producing a composite article;

FIG. 2 is a schematic view illustrating a mold for hot pressing a stack of prepreg sheets by the conventional method;

FIG. 3 is a flowchart showing a method of producing a composite article according to the first embodiment of the present invention;

FIG. 4 is a schematic view illustrating upper and lower mold halves of a mold for hot pressing a stack of prepreg sheets by the method according to the first embodiment of the present invention;

FIG. 5 is a fragmentary enlarged top view of a forming pattern according to the present invention;

FIG. 6 is a fragmentary cross-sectional view of the stack of prepreg sheets used in the first embodiment of the present invention;

FIG. 7 is a fragmentary enlarged cross-sectional view of a composite article having a fine ridge pattern made by the method of the present invention;

FIG. 8 is a flowchart showing a method of producing a composite article according to the third embodiment of the present invention; and

FIG. 9 is a flowchart showing a method of producing a composite article according to the fourth embodiment of the present invention.

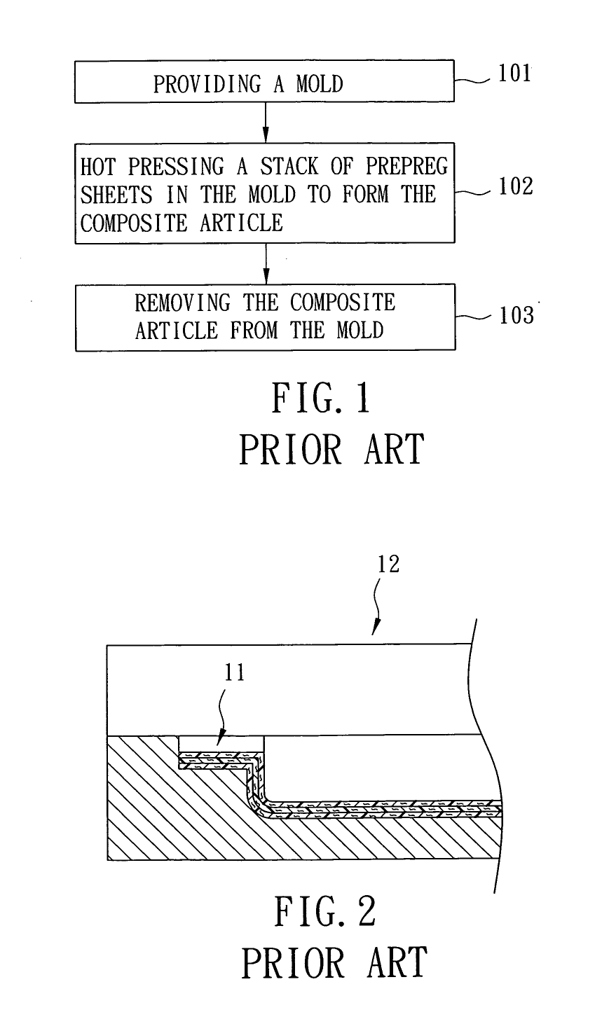

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

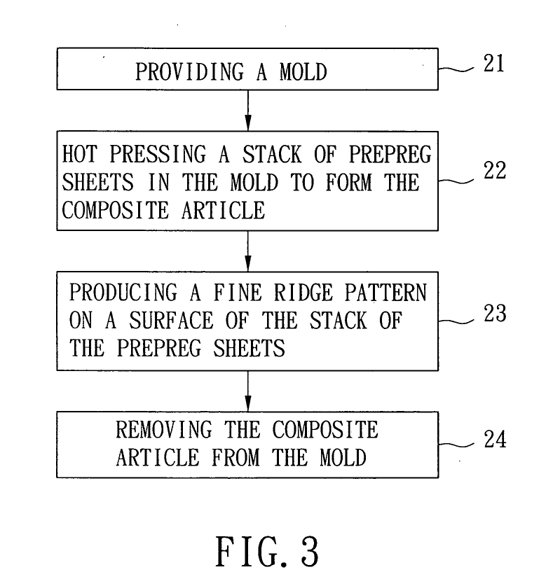

Referring to FIG. 3, the first embodiment of the method of producing a composite article according to this invention comprises: step 21 of providing a mold; step 22 of hot pressing a stack of prepreg sheets in the mold to form the composite article; step 23 of producing a fine ridge pattern on a surface of the stack of the prepreg sheets; and step 24 of removing the composite article from the mold.

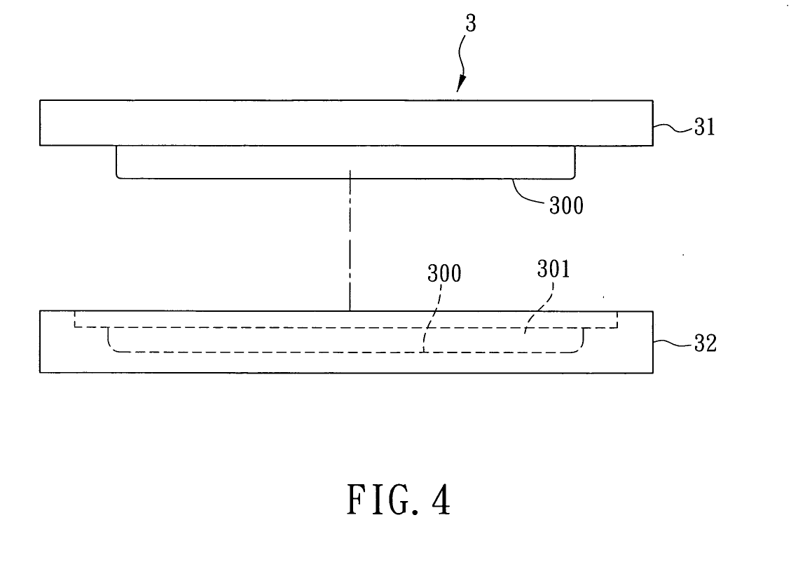

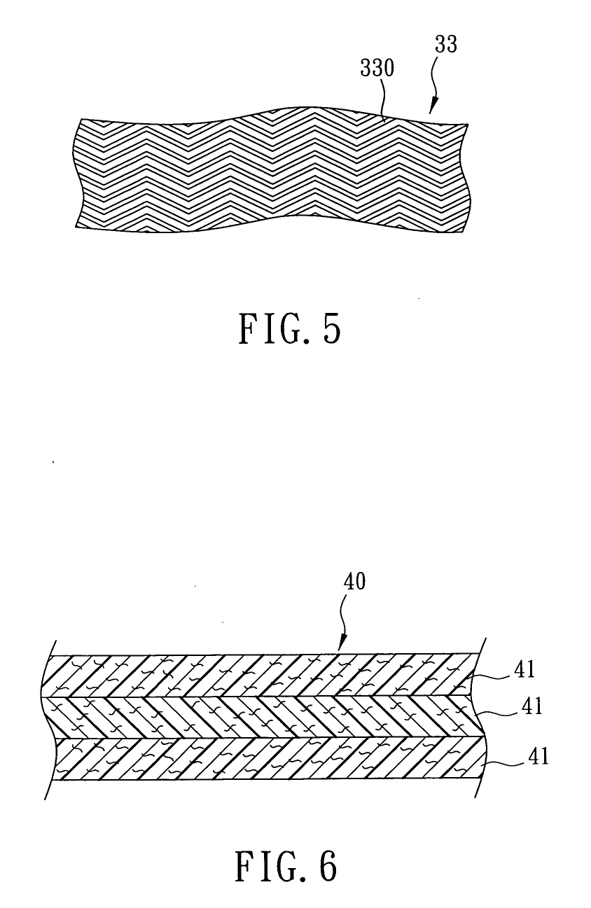

In step 21, a mold 3 is provided (see FIG. 4). The mold 3 includes upper and lower mold halves 31, 32, and the lower mold half 32 has a mold cavity 301. An inner surface 300 of the lower mold half 32 is provided with a forming pattern 33 as shown in FIG. 5. The forming pattern 33 includes ridges 330 which are substantially as fine as the ridges of a fingerprint.

After the inner surface 300 of the lower mold half 32 of the mold 3 is mirror polished, the forming pattern 33 is formed in the mold 3 by a method, such as a computer numerical control process, electrical discharge machining, etching, roller pressing, etc.

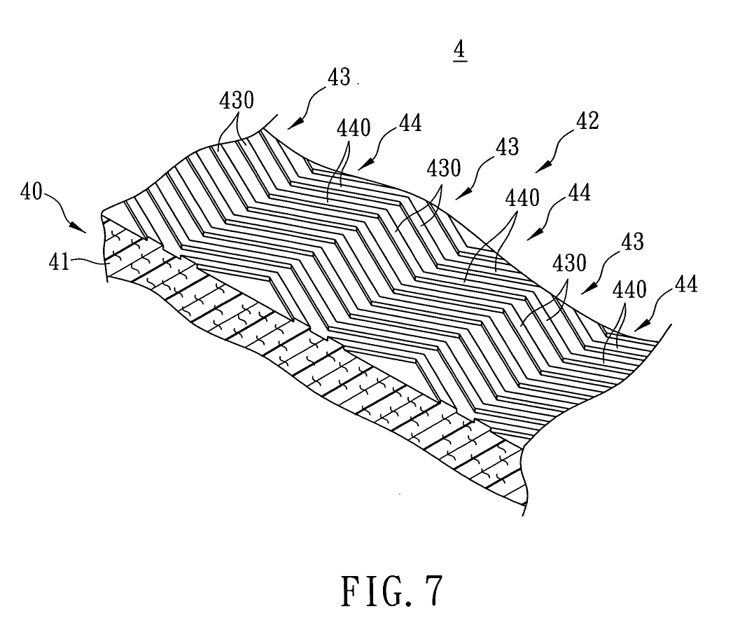

Steps 22 and 23 are performed simultaneously. A stack 40 of prepreg sheets 41 (i.e., resin-impregnated fabric sheets) shown in FIG. 6 is hot pressed in the mold 3 to form a composite article 4 (see FIG. 7). A fine ridge pattern 42 shown in FIG. 7 is printed and produced on a surface of the prepreg sheets 41 by the forming pattern 33 during the hot pressing of the prepreg sheets 41.

In step 24, the composite article 4 with the fine ridge pattern 42 is removed from the mold 3.

In the preferred embodiment, as shown in FIG. 7, the fine ridge pattern 42 has a plurality of parallel first and second stripe regions 43, 44 which are arranged in alternate rows. Each of the first stripe regions 43 has a plurality of parallel first ridges 430 which are formed slantingly along a first slanting direction. Each of the second stripe regions 44 has a plurality of parallel second ridges 440 which are formed slantingly along a second slanting direction that forms an angle with the first slanting direction.

Each of the first ridges 430 in each of the first stripe regions 43 is contiguous to one of the second ridges 440 in each of two adjacent ones of the second stripe regions 44 such that the contiguous first and second ridges 430, 440 form a zigzag shape.

Since the inner surface 300 of the lower mold half 32 is formed with the forming pattern 33 as shown in FIG. 5, during hot pressing, air inside the prepreg sheets 41 will flow to the forming pattern 33 together with the resin of the prepreg sheets 41. Due to the provision of the forming pattern 33, the air inside the prepreg sheets 41 can easily flow to the surface of the prepreg sheets 41 contiguous to the forming pattern 33 and thereafter to the vents of the mold 3 through the forming pattern 33 of the mold 3. After hot pressing, the resin of the prepreg sheets 41 is cured and formed with the fine ridge pattern 42 which is imparted by the forming pattern 33. Accordingly, the first and second ridges 430, 440 of the fine ridge pattern 42 are also substantially as fine as the ridges of a fingerprint.

Therefore, with the method of the present invention, formation of the pin holes and the bubbles can be alleviated, and the structural strength of the composite article 4 can be improved. In addition, the composite article 4 is provided with a good outer appearance without using any coating material.

Moreover, since no additional steps for removing the pin holes and bubbles is necessary, the cost for producing the composite article 4 is also reduced.

According to the second embodiment of the method of producing a composite article of this invention, the forming pattern 33 can be formed on the inner surfaces 300 of both of the upper and lower mold halves 31, 32. In this case, the air among the prepreg sheets 41 can be released from the mold 3 more efficiently.

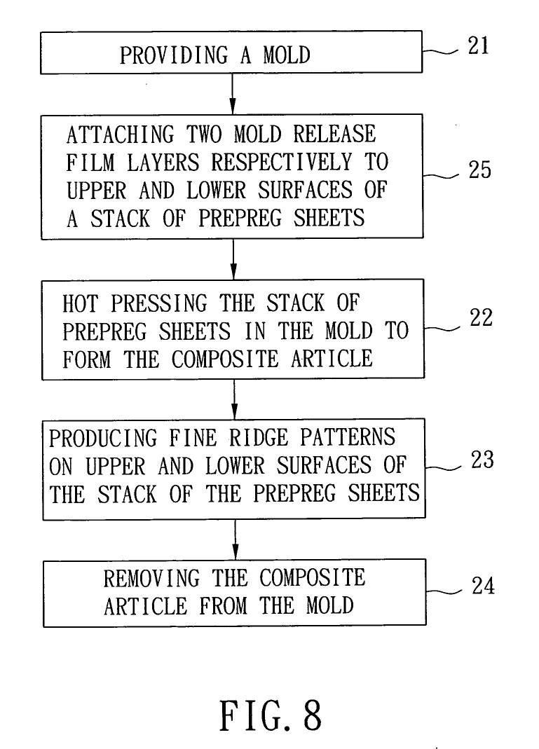

FIG. 8 illustrates the third embodiment of the method of producing a composite article 4 of this invention. The third embodiment differs from the second embodiment only in that the method of the third embodiment further comprises a step 25 of attaching two mold release film layers (not shown) respectively to upper and lower surfaces of the stack 40 of the prepreg sheets 41 before the step 22 of hot pressing. In this embodiment, the forming patterns 33 of the mold 3 are respectively printed on the mold release film layers, and are thereafter transferred to the upper and lower surfaces of the stack 40 of the prepreg sheets 41 from the mold release film layers, thereby producing the fine ridge patterns 42 respectively on the upper and lower surfaces of the stack 40 of the prepreg sheets 41. The mold release film layers are removed from the composite article 4 after the composite article 4 is removed from the mold 3.

By using the mold release film layers, the resin contained in the prepreg sheets 41 can be prevented from adhering to the upper and lower mold halves 31, 32 of the mold 3. The mold release film layer can be made of polyethylene terephthalate, ortho-phenylphenol, or a combination thereof. By virtue of the mold release film layers, removal of the composite article 4 from the mold 3 can be facilitated.

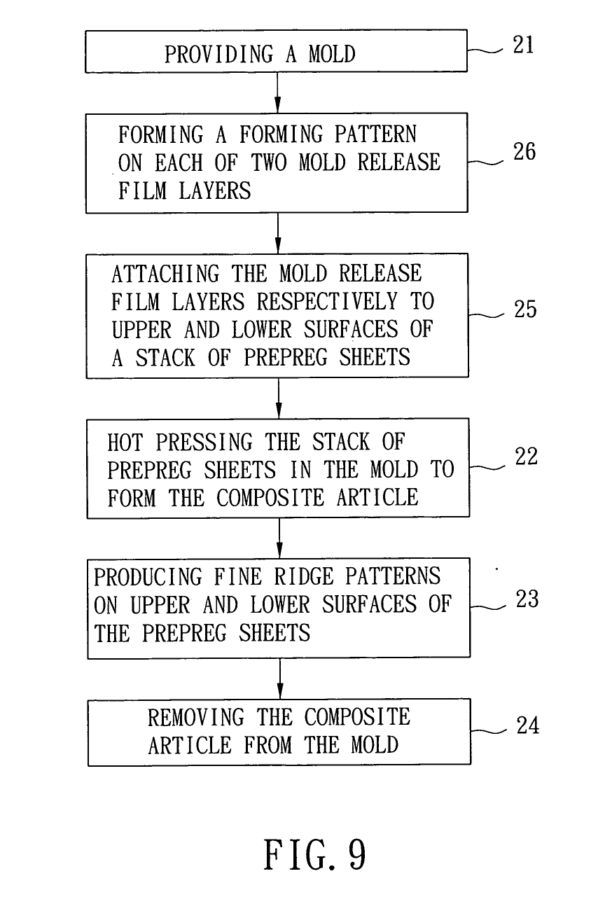

FIG. 9 illustrates the fourth embodiment of the method of producing a composite article 4 of this invention. The fourth embodiment differs from the third embodiment only in that the method of the fourth embodiment further comprises a step 26 of forming the forming pattern 33 (FIG. 5) on each of the mold release film layers, and that the mold for hot pressing the composite article 4 is not provided with the forming pattern 33.

In this embodiment, during the hot pressing of the prepreg sheets, the forming patterns 33 of the mold release film layers are respectively printed and produced on the upper and lower surfaces of the stack 40. The mold release film layers are removed from the composite article 4 after the composite article 4 is removed from the mold 3.

Each of the mold release film layers has a release surface facing one of the inner surfaces 300 of the mold 3, and a patterned surface facing one of the upper and lower surfaces of the stack 40. In each mold release film layer, the forming pattern 33 is formed on the patterned surface of the mold release film layer.

The forming pattern 33 of each mold release film layer can be formed by processing the mold release film layers using stereolithography or roller pressing.

It should be noted that the method of the present invention should not be limited to the use of the mold 3 shown in FIG. 4, and any other mold that is used conventionally to hot press prepreg sheets can be used in the present invention.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method of producing a composite article, comprising:
hot pressing a stack of prepreg sheets in a mold to form the composite article, the mold having a mold cavity;
producing a fine ridge pattern on a surface of the stack of the prepreg sheets during the hot pressing of the prepreg sheets in the mold cavity, the fine ridge pattern having a plurality of ridges which are substantially as fine as those of a fingerprint; and
removing the composite article from the mold cavity.

2. The method of claim 1, wherein the fine ridge pattern further has a plurality of parallel first and second stripe regions which are arranged in alternate rows, the ridges of the fine ridge pattern including a plurality of parallel first ridges which are formed slantingly in each of the first stripe regions, and a plurality of parallel second ridges which are formed slantingly in each of the second stripe regions, the first ridges having a first slanting direction, the second ridges having a second slanting direction that forms an angle with the first slanting direction.

3. The method of claim 2, wherein each of the first ridges in each of the first stripe regions is contiguous to one of the second ridges in each of two adjacent ones of the second stripe regions such that the contiguous first and second ridges form a zigzag shape.

4. The method of claim 1, further comprising providing on an inner surface of the mold a forming pattern that produces the fine ridge pattern.

5. The method of claim 4, further comprising attaching a mold release film layer to the surface of the stack of the prepreg sheets before the step of hot pressing so that the forming pattern of the mold is printed on the mold release film layer, and is thereafter transferred to the surface of the stack of the prepreg sheets from the mold release film layer during the step of hot pressing, wherein the mold release film layer is removed from the composite article after the composite article is removed from the mold.

6. The method of claim 5, wherein the mold release film layer is made of a material selected from a group consisting of polyethylene terephthalate, ortho-phenylphenol, and a combination thereof.

7. The method of claim 4, wherein the forming pattern is formed on the inner surface of the mold through a computer numerical control process.

8. The method of claim 4, wherein the forming pattern is formed directly on the inner surface of the mold by an electrical discharge machining process.

9. The method of claim 4, wherein the forming pattern is formed directly on the inner surface of the mold by an etching process.

10. The method of claim 4, wherein the forming pattern is formed directly on the inner surface of the mold by a roller pressing process.

11. The method of claim 1, further comprising forming a forming pattern on a mold release film layer, and attaching the mold release film layer to the surface of the stack of the prepreg sheets before the step of hot pressing so that the forming pattern of the mold release film layer is printed and produced on the surface of the stack of the prepreg sheets, wherein the mold release film layer is removed from the composite article after the composite article is removed from the mold.

12. The method of claim 11, wherein the mold release film layer is made of a material selected from a group consisting of polyethylene terephthalate, ortho-phenylphenol, and a combination thereof.

13. The method of claim 11, wherein the mold release film layer is provided with the forming pattern by stereolithography.

14. The method of claim 11, wherein the mold release film layer is provided with the forming pattern by roller pressing.
